(19) United States
(12) Patent Application Publication
(10) Pub. No.: US 2007/0104070 A1
(43) Pub. Date: May 10, 2007

(54) Optical pickup apparatus

(75) Inventor: Takahiro Miyake, Kyoto (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/583,320

(22) Filed: Oct. 18, 2006

(30) Foreign Application Priority Data
Oct. 20, 2005 (JP) 2005-306245

(51) Int. Cl. G11B 7/00

(52) U.S. Cl. 369/112.01

(57) ABSTRACT

An optical pickup apparatus is realized that (i) allows an aberration in a spot of light converged by an objective lens to be reduced and (ii) has a uniform focusing characteristic, close to an ideal state, of a main beam which is a 0th-order diffracted light beam, without reducing efficiency in utilizing light. An optical pickup apparatus of the present invention includes: a light source that emits a light beam; light converging means for converging the light beam to a storage medium; and a grating that guides the light beam to the light converging means. The light converging means converges, to the storage medium via the grating, the light beam emitted from the light source. The grating includes grating grooves that cause a first astigmatism to be generated in a manner such that the first astigmatism offsets a second astigmatism caused by the light source. Therefore, it is possible to converge light beams to a spot that is similar in dimension to a spot to be formed in the case where there is no aberration. Accordingly, an optical pickup apparatus having an excellent focusing characteristic is provided.

This Nonprovisional application claims priority under 35 U.S.C. § 119(a) on Patent Application No. 306245/2005 filed in Japan on Oct. 20, 2005, the entire contents of which are hereby incorporated by reference.

### FIELD OF THE INVENTION

The present invention relates to an optical pickup apparatus used in an optical recording and reproducing apparatus that performs optical recording and/or reproduction of information with a storage medium such as optical disks. The present invention also relates to an optical recording and reproducing apparatus including the optical pickup apparatus.

### BACKGROUND OF THE INVENTION

Conventionally, optical pickup apparatuses are used in recording and reproducing information with the use of a storage medium such as compact disks, laser disks, recordable optical disks, and re-writable optical disks. With an optical pickup apparatus, information is recorded and reproduced by causing a light beam emitted from a semiconductor laser light-source to illuminate a recording surface and a memory surface of the storage medium, and using light that is reflected from the recording surface and the memory surface.

An intensity distribution of light beams emitted from the semiconductor laser light source is normally a Gaussian distribution. Accordingly, an intensity distribution of light beams that enter an objective lens also becomes a Gaussian distribution. Therefore, intensity of light at the objective lens decreases at greater distances from a central area of the objective lens.

Further, a light beam emitted from the semiconductor laser light source has a characteristic in which its radiation surface spreads differently between (a) a radiation surface parallel to a direction in which layers are laminated in a laser chip that emits a light beam and (b) a radiation surface perpendicular to the direction. This causes an astigmatic difference to be generated at the semiconductor laser light source. Specifically, a virtual-source location differs between (i) in a direction parallel to the direction in which the layers are laminated in the laser chip and (ii) in a direction perpendicular to the direction in which the layers are laminated in the laser chip. Consequently, a light beam including astigmatism is emitted from the semiconductor laser light source.

This does not allow the light beam emitted from the semiconductor laser light source to be converged to a micro-spot on a storage medium such as optical disks, and therefore a time base resolution of a reproduction signal decreases. Further, a signal recorded in an adjacent track is introduced, as a crosstalk component, to the reproduction signal. This causes a problem that an S/N ratio of the reproduction signal is deteriorated.

There is a known method for improving an intensity distribution of light beams. In the method, a grating is modified that is used in diverging, in a direction of a light receiving device, light that is reflected from a storage medium such as optical disks (see for example Patent Document 1).

In the method, the grating is used that includes grating grooves whose widths and depths are serially changed. This makes it possible to differentiate, at different areas of the grating, diffraction efficiency with respect to a 0th-order diffracted light beam that is to enter the objective lens. By this way, the intensity distribution of light beams is controlled.

FIG. 14 is a plan view showing an exemplary grating 103 of a conventional optical pickup apparatus.

As shown in FIG. 14, the grating 103 includes, on a grating surface thereof, grating ridges 103a each having a width 103a_{w} and grating grooves 103b each having a width 103b_{w}.

The grating grooves 103b are formed in a grating-groove direction 103b_{d} on the grating surface of the grating 103. In a direction 103b_{d}′, which is perpendicular to the grating-groove direction 103b_{d}, the grating ridges 103a and the grating grooves 103b of the grating 103 are formed in a manner such that 103a_{w}/103b_{w} approximates to 1 in a central area 1011 and to an infinity in peripheral areas 1012 and 1013.

In this structure, diffraction efficiency of light beams gently decreases at greater distances from the center of the grating 103 toward an outer edge area of the grating 103. Therefore, an intensity of a luminous flux that passes through the center of the grating 103 becomes lower, whereas an intensity of a luminous flux that passes through the outer edge area becomes higher. Accordingly, an intensity distribution of light beams becomes nearly flat.

In the foregoing manner, it is possible with the grating 103 to shape an intensity distribution of laser luminous flux so that desired reproduction characteristics are obtained, which laser luminous flux is to enter the objective lens and to be used in reproduction of signals.

In the conventional structure described above, however, if a width or depth of the grating grooves of the grating is changed, a phase difference would be generated, in accordance with an amount of change in the width or depth, in light that passes through the grating. This causes a problem that astigmatism is generated. Specifically, a phase in a light spot gently deviates from the central area toward a peripheral area. Furthermore, in the case where astigmatism is caused by the grating in the same direction as that of astigmatism caused by the light source, a problem arises that the astigmatism is emphasized further. This does not allow light to be converged to a smaller spot on the storage medium due to the astigmatism. Thus, sufficient recording/reproduction characteristics are not obtained.

[Patent Document 1]

Japanese Unexamined Patent Publication no. 2001-134972 (published on May 18, 2001)

### SUMMARY OF THE INVENTION

The present invention is in view of the above problems, and has as an object to provide an optical pickup apparatus that allows light to be converged to a smaller spot on a storage medium so that recording and/or reproduction is suitably performed with the storage medium.

To achieve the above object, an optical pickup apparatus according to the present invention is adapted so that the optical pickup apparatus includes: a light source that emits a light beam; light converging means for converging the light beam to a storage medium; and a grating that guides the light beam to the light converging means, the light converging means converging, to the storage medium via the grating, the light beam emitted from the light source, and the grating including grating grooves that cause a first astigmatism to be generated in a manner such that the first astigmatism offsets a second astigmatism caused by the light source.

In the above structure, the grating causes a first astigmatism to be generated in a manner such that the first astigmatism offsets a second astigmatism caused by the light source. This produces an advantage that an astigmatism in light having passed through the grating is improved.

Further, the optical recording and reproducing apparatus according to the present invention is adapted so that the optical recording and reproducing apparatus includes the optical pickup apparatus.

In the above structure, the optical pickup apparatus has a focusing characteristic that is similar in dimension to a spot to be formed in the case where there is no aberration. This produces an advantage that an optical recording and reproducing apparatus is provided that suitably performs recording and/or reproduction with a storage medium.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a sectional view illustrating a schematic structure of an optical pickup apparatus according to an embodiment of the present invention.

FIG. 2 is an explanatory diagram for explaining how a light beam is diffracted when passing through a grating of the optical pickup apparatus.

FIG. 3 is a sectional view illustrating a configuration of a grating of the optical pickup apparatus.

FIG. 4 is a plan view illustrating a concrete configuration of a grating of the optical pickup apparatus.

FIG. 5(a) is an explanatory diagram for explaining a location of a virtual source of a light beam in the optical pickup apparatus before the light beam passes through a grating.

FIG. 5(b) is an explanatory diagram for explaining a location of a virtual source of a light beam in the optical pickup apparatus after the light beam passes through a grating.

FIG. 6(a) is an explanatory diagram for explaining a location of a virtual source of a light beam in the optical pickup apparatus before the light beam passes through a grating.

FIG. 6(b) is an explanatory diagram for explaining a location of a virtual source of a light beam in the optical pickup apparatus after the light beam passes through a grating.

FIG. 7(a) is an explanatory diagram for explaining a location of a virtual source of a light beam in the optical pickup apparatus before the light beam passes through a grating.

FIG. 7(b) is an explanatory diagram for explaining a location of a virtual source of a light beam in the optical pickup apparatus after the light beam passes through a grating.

FIG. 8(a) is an explanatory diagram for explaining a location of a virtual source of a light beam in the optical pickup apparatus before the light beam passes through a grating.

FIG. 8(b) is an explanatory diagram for explaining a location of a virtual source of a light beam in the optical pickup apparatus after the light beam passes through a grating.

FIG. 9 is a plan view illustrating a concrete configuration of a grating of an optical pickup apparatus, according to another embodiment of the present invention.

FIG. 10 is a sectional view illustrating a schematic structure of an optical pickup apparatus according to another embodiment of the present invention.

FIG. 11 is an explanatory diagram for explaining how a light beam is diffracted when passing through a grating of the optical pickup apparatus illustrated in FIG. 10.

FIG. 12 is a plan view illustrating a schematic configuration of a grating of the optical pickup apparatus illustrated in FIG. 10.

FIG. 13 is a plan view illustrating a concrete configuration of a grating of an optical pickup apparatus, according to another embodiment of the present invention.

FIG. 14 is a plan view illustrating a schematic configuration of a grating, according to a conventional technique.

### DESCRIPTION OF THE EMBODIMENTS

### Embodiment 1

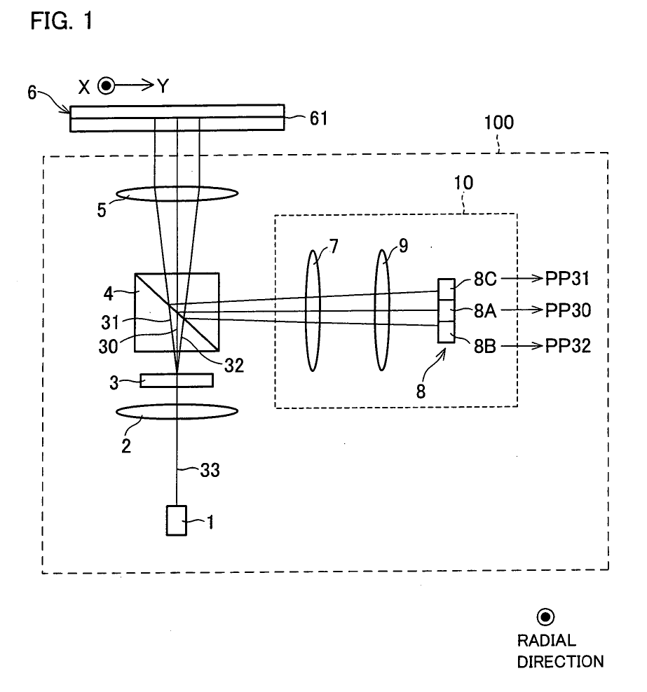

The following describes in detail Embodiment 1 of the present invention, with reference to FIGS. 1 to 8.

FIG. 1 is a sectional view illustrating a schematic structure of an optical pickup apparatus 100 of the present invention. As shown in FIG. 1, the optical pickup apparatus 100 includes a semiconductor laser (light source) 1, a collimator lens 2, a grating 3, a beam splitter 4, an objective lens (light converging means) 5, and a push-pull signal detecting section 10.

An optical disk (storage medium) 6 is any optical disk that performs reproduction and recording by use of light, including read-only pit disks, phase-change disks, which are writable, readable, and erasable, magneto-optical disks, and recordable disks, which are recordable and reproducible.

The collimator lens 2 changes a light beam 33, which is emitted from the semiconductor laser 1, so that the light beam 33 becomes parallel light. The grating 3 splits the light beam 33 having entered the grating 3 into three diffracted light beams, a 0th-order diffracted light beam and ±1st-order diffracted light beams, and then guides the three diffracted light beams to the objective lens 5. A concrete configuration of the grating 3 will be described below.

The beam splitter 4 allows a light beam coming from the semiconductor laser 1 to pass therethrough. Further, the beam splitter 4 reflects a light beam having been reflected by the optical disk 6, so that the light beam is guided to a light receiving device 8 in the push-pull signal detecting section 10.

The push-pull signal detecting section 10 includes a convergent lens 7, a cylindrical lens 9, and a light receiving device 8. The convergent lens 7 converges incident light. The cylindrical lens 9 converges only a light beam of one direction, out of the incident light. The light receiving device 8 detects a 0th-order diffracted light beam reflected from the optical disk 6 and a pair of ±1st-order diffracted light beams reflected from the optical disk 6.

After emitted from the semiconductor laser 1, the light beam 33 enters the collimator lens 2, is changed to parallel light, and then is guided to the grating 3. After entering the grating 3, the light beam is split into a main beam 30, which is a 0th-order diffracted light beam, a sub beam 31, which is a +1st-order diffracted light beam, and a sub beam 32, which is a −1st-order diffracted light beam, and then passes through the beam splitter 4. After passing through the beam splitter 4, the light beam (main beam 30, sub beam 31, and sub beam 32) is converged, by the objective lens 5, to a track 61 at the optical disk 6. After converged to the track 61 at the optical disk 6, the light beam, in three separate light beams of the main beam 30 and the sub beams 31 and 32, is reflected so that the light beam becomes a reflected light beam.

After reflected by the optical disk 6, the reflected light beam passes through the objective lens 5, is reflected by the beam splitter 4, and then passes through the convergent lens 7 and the cylindrical lens 9. Thereafter, the reflected light beam, in three separate light beams of the main beam 30 and the sub beams 31 and 32, is guided to the light receiving device in the push-pull signal detecting section 10.

The light receiving device 8 detects a light beam having reflected by the optical disk 6. The light receiving device 8 includes a light receiving device 8A, a light receiving device 8B, and a light receiving device 8C. Each of the light receiving device 8A, the light receiving device 8B, and the light receiving device 8C (hereinafter, referred to as light receiving devices 8A, 8B, 8C) is a light receiving device that is divided into two by a division line in a track direction. The light receiving devices 8A, 8B, 8C receive the main beam 30, the sub beam 32, and the sub beam 31, respectively. In the light receiving device 8, the light receiving devices 8A, 8B, 8C produce difference signals, a push-pull signal PP30, a push-pull signal PP32, and a push-pull signal PP31, respectively. Note that, in FIG. 1, the track direction at the light receiving devices 8A, 8B, 8C is rotated by 90 degrees by the cylindrical lens 9.

The grating 3 is formed such that a diminishing rate of intensity of the 0th-order diffracted light beam decreases at greater distances from the vicinity of an optical axis toward a peripheral area, and that intensity of the respective ±1st-order diffracted light beams decreases at greater distances from the vicinity of an optical axis toward a peripheral area. Further, the grating 3 is designed such that a spread of a radiation surface, perpendicular with respect to the grating grooves, of the 0th-order diffracted light beam is changed by a structure of the grating so that astigmatism is corrected.

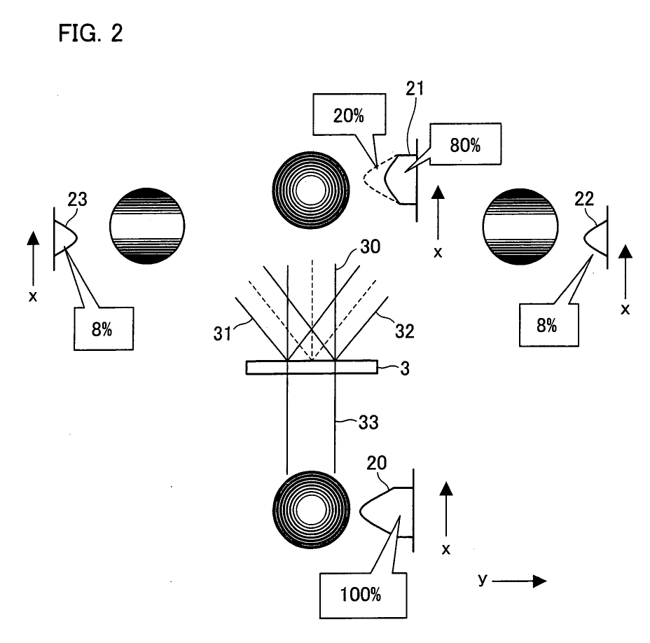

The following describes how the grating 3 affects intensity of light, with reference to FIG. 2.

FIG. 2 is an explanatory diagram for explaining how a light beam is diffracted when passing through the grating 3 in the optical pickup apparatus 100. FIG. 2 shows a grating 3 that causes a light beam emitted from the semiconductor laser 1 to be split, by the light-quantity ratio of 1:10:1=−1st-order diffracted light beam: 0th-order diffracted light beam: +1st-order diffracted light beam, into a −1st-order diffracted light beam, a 0th-order diffracted light beam, and a +1st-order diffracted light beam. The light-quantity ratio by which the grating 3 diffracts light, however, is not limited to the ratio mentioned above. Further, in the present embodiment, a direction (hereinafter, radial direction) that corresponds to a radial direction of the optical disk 6 is named a direction x, and a direction (hereinafter, track direction) that is orthogonal to the radial direction, i.e., a length direction of the track at the optical disk 6, is named direction y.

As shown in FIG. 2, in the case where the grating 3 causes the light beam to be split, by the light-quantity ratio of 1:10:1, into a −1st-order diffracted light beam, a 0th-order diffracted light beam, and a +1st-order diffracted light beam, diffraction efficiency of the grating 3 is −1st-order diffracted light beam: 0th-order diffracted light beam: +1st-order diffracted light beam=8%: 80%: 8%. The remaining 4% of the diffraction efficiency of the grating 3 are diffraction efficiency of second or higher order diffracted light beams.

An intensity distribution 20, which is a Gaussian intensity distribution, in FIG. 2 shows a distribution of intensity in the direction x of the light beam 33 emitted from the semiconductor laser 1. When passing through the grating 3, the light beam 33 is split into the main beam 30, which is a 0th-order diffracted light beam, and the pair of sub beams 31 and 32, which pair is a pair of ±1st-order diffracted light beams. An intensity distribution 21 shows a distribution of intensity, in the direction x, of the light beam 33 that has outgone from the grating 3. The intensity distribution 21 of the main beam 30 is a uniform intensity distribution in which the vicinity of the optical axis is cut. The quantity of light that is cut in the vicinity of the optical axis in the intensity distribution 21 is 20% of the entire quantity of the light beam 33 emitted from the semiconductor laser 1. As the foregoing describes, the grating 3 causes the main beam 30 to change so that the main beam 30 becomes a 0th-order diffracted light beam whose intensity distribution is uniform and closer to flat.

On the other hand, 16% of the entire quantity of the light beam 33 emitted from the semiconductor laser 1 is changed to the sub beam 31 and the sub beam 32. Specifically, each quantity of the sub beam 31 and the sub beam 32 is 8% of the entire quantity of the light beam 33 emitted from the semiconductor laser 1. Further, as shown in FIG. 2, distributions of intensities, in the direction x, of the sub beams 31 and 32 become as shown in an intensity distribution 23 and an intensity distribution 22, respectively. In each of the distributions, the intensity gently decreases at greater distances, in the direction x, from the vicinity of the optical axis.

Accordingly, the grating 3 functions to improve the respective intensity distributions of the main beam 30, the sub beam 31, and the sub beam 32. Specifically, the grating 3 functions such that, with respect to the main beam 30, the distribution of intensity in the direction x becomes uniform and closer to flat, and, with respect to the sub beams 31 and 32, the respective distributions of intensities in the direction x decrease at greater distances, in the direction x, from the vicinity of the optical axis. In other words, the grating 3 functions to improve Rim intensity of each of the main beam 30 and the sub beams 31 and 32. More specifically, the grating 3 functions to increase Rim intensity, in the direction x, of the main beam 30 and to decrease respective Rim intensities, in the direction x, of the respective sub beams 31 and 32. The “Rim intensity” indicates a ratio of a light intensity of luminous flux that passes through an outer edge area of the objective lens, with respect to a light intensity of luminous flux that passes through the central area of the objective lens 5.

The grating 3 is formed such that the respective distributions of intensities, in the direction x, of the main beam 30 and the sub beams 31 and 32 are improved. The grating 3, however, is not limited to this configuration. It is also possible to form the grating 3 such that the distributions of intensities in the direction y are improved.

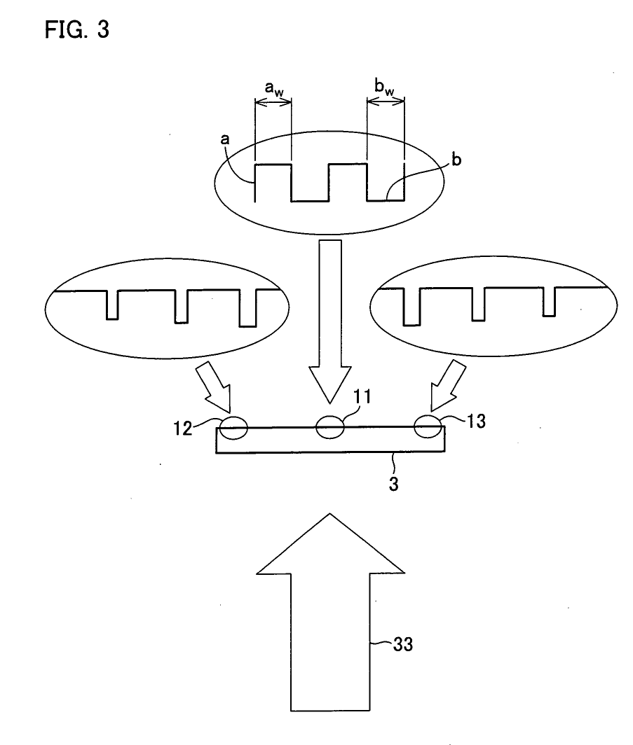

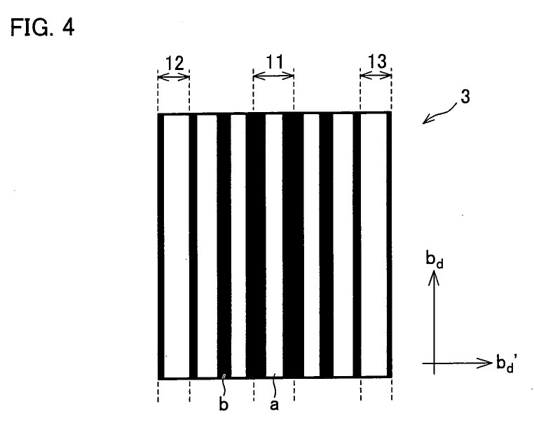

The following describes a concrete configuration of the grating 3, with reference to FIGS. 3 and 4. FIG. 3 is a sectional view illustrating a configuration of the grating 3. FIG. 4 is a plan view illustrating a concrete configuration of the grating 3, showing a grating surface of the grating.

As shown in FIG. 3, a grating surface is formed on a surface of the grating 3, which surface is closer to the objective lens 5 (objective-lens side). The grating surface is in rectangular shape and includes grating ridges a each having a width a_{w} and grating grooves b each having a width b_{w}. The grating 3 is formed such that a direction of the grating grooves b are perpendicular with respect to a direction of a surface (radiation surface with a narrow spread from the light source) that is parallel to a radiation angle of a light beam emitted from the semiconductor laser 1. Further, a ratio of the width of the grating ridges a with respect to the width of the grating grooves b (hereinafter, the ratio will be referred to as a_{w}/b_{w}) differs between the central area 11 of the grating 3 and the peripheral areas 12 and 13 of the grating 3.

In the present embodiment, the central area 11 is an area of the grating surface of the grating 3, through which area a luminous flux, in the vicinity of the optical axis, of the light beam 33 emitted from the semiconductor laser 1 passes. Further, the peripheral area 12 and the peripheral area 13 are areas of the grating surface of the grating 3, through which areas a luminous flux, in the vicinity of outer edge areas, of the light beam 33 emitted from the semiconductor laser 1 passes.

As shown in FIG. 3, the grating ridges a and the grating grooves b of the grating 3 are formed in a manner such that a_{w}/b_{w} approximates to 1 in the central area 11 and approximates to infinity in the peripheral areas 12 and 13. In other words, the grating ridges a and the grating grooves b of the grating 3 are formed in a manner such that a_{w}/b_{w} approximates to infinity at greater distances from the central area 11 toward the peripheral areas 12 and 13.

In the above configuration, light intensity of the 0th-order diffracted light beam that passes through the grating 3, i.e., the main beam 30, decreases in such a way that light intensity of a luminous flux decreases at a higher diminishing rate in the vicinity of the optical axis than in the outer edge areas. In other words, light intensity of a luminous flux of the main beam 30 becomes lower in the vicinity of the optical axis and higher in the outer edge area. At this time, the light-intensity distribution becomes closer to flat. For example, the light-intensity distribution changes from the intensity distribution 20 to the intensity distribution 21. Thereafter, the main beam 30 enters the objective lens 5. By this way, it becomes possible to narrow a spot on the optical disk 6 so that the spot becomes smaller. It thus becomes possible to improve resolution of a reproduction signal from the optical disk 6.

Further, the grating grooves b of the grating 3 is formed such that the proportion of the grating grooves b decreases at greater distances from the central area 11 toward the peripheral areas 12 and 13. This causes the spread of the radiation surface of the main beam 30 having passing through the grating 3 to become wider in a direction of a surface parallel to the radiation angle. In other words, the grating 3 functions as a concave lens so as to widen the spread of the radiation surface of the light beam, which radiation surface is in the direction of the surface parallel to the radiation angle, which direction is perpendicular to the direction of the grating grooves. More concretely, the grating 3 is formed to function as a cylindrical concave lens in such a way that the grating 3 functions as a concave lens to widen a radiation surface only with respect to the radiation surface of the light beam, which radiation surface is perpendicular to the direction of the grating grooves, but does not function with respect to the surface (radiation surface with a wide spread from the light source) that is parallel to the direction of the grating grooves and perpendicular to the radiation angle of the light beam. This significantly reduces aberration in the light beam 30 having passed through the grating 3. It thus becomes possible for the objective lens 5 to converge light beams to a spot that is similar in dimension to a spot to be formed in the case where there is no aberration.

The following describes a configuration of the grating surface of the grating 3, with reference to FIG. 4.

The grating 3 is, for example, a relief grating formed with a predetermined pitch on a glass substrate. By gently changing, as shown in FIG. 4, the widths of the grating grooves or the depths of the grating grooves in the direction b_{d}′, which is perpendicular to the direction b_{d} of the grating grooves, it is possible to make the diffraction efficiency gently decrease from the center along the direction b_{d}′ in the distribution.

As shown in FIG. 4, the grating surface of the grating 3 includes the grating ridges a each having the width a_{w} and the grating grooves b each having the width b_{w}. The grating 3 is placed in a manner such that the direction b_{d} of the grating grooves becomes perpendicular with respect to the direction of the surface that is parallel to the radiation angle of the light beam emitted from the semiconductor laser 1.

The grating grooves b are formed in the direction b_{d} of the grating grooves on the grating surface of the grating 3. Further, the grating ridges a and the grating grooves b are formed in the direction b_{d}′ such that a_{w}/b_{w} approximates to 1 in the central area 11 and to infinity in the peripheral areas 12 and 13. In other words, the grating ridges a and the grating grooves b of the grating 3 are formed in a manner such that a_{w}/b_{w} approximates to infinity at greater distances from the central area 11 toward the peripheral areas 12 and 13. In this case, the light-intensity distribution of the main beam 30 becomes closer to flat, in the direction in which a_{w}/b_{w} is to be changed, i.e., the direction b_{d}′, and thereafter the main beam 30 enters the objective lens 5. By this way, it becomes possible in the direction b_{d}′ to narrow a spot on the optical disk 6 so that the spot becomes smaller.

The spread of the radiation surface of the main beam 30 having passed through the grating 3 becomes wider in the direction of the surface parallel to the radiation angle at the light source. In other words, the grating 3 functions as a concave lens to widen the spread of the radiation surface in the direction of the surface parallel to the radiation angle at the light source, which direction is in the direction b_{d}′. More concretely, the grating 3 is formed to function as a cylindrical concave lens in such a way that the grating 3 functions as a concave lens to widen the spread of the radiation surface only with respect to the direction of the surface parallel to the radiation angle at the light source, which direction is perpendicular to the direction of the grating grooves, but does not function with respect to the direction of the surface that is perpendicular to the radiation angle at the light source, which direction is parallel to the direction of the grating grooves.

As described above, the grating surface of the grating 3 is formed such that, in the direction b_{d}′, the intensity distributions of the main beam 30 and the sub beams 31 and 32 are improved, and, at the same time, astigmatism in the main beam 30 having passed through the grating 3 is corrected. This significantly reduces aberration in the 0th-order diffracted light beam having passed through the grating 3. It thus becomes possible for the objective lens 5 to converge light beams to a spot that is similar in dimension to a spot to be formed in the case where there is no aberration.

As the foregoing describes, in the case where the radiation surface with the wide spread from the light source is in the direction b_{d}′, the grating surface of the grating 3 is produced in such a way that the ratio a/b of the grating ridges a to the grating grooves b changes from 1 to infinity at greater distances from the central area 11 along the direction b_{d}′.

Further, it is also possible to place the grating 3 such that the direction b_{d} of the grating grooves becomes perpendicular with respect to the direction of the surface perpendicular to the radiation angle of the semiconductor laser 1.

In this case, the grating surface of the grating 3 is produced in such a way that the ratio a/b of the grating ridges a to the grating grooves b changes from 1 to 0 at greater distances from the central area 11 along the direction b_{d}′. This causes the light-intensity distribution of the main beam 30 to become closer to flat, in the direction b_{d}′, and thereafter the main beam 30 enters the objective lens 5. By this way, it becomes possible in the direction b_{d}′ to narrow a spot on the optical disk 6 so that the spot becomes smaller.

The spread of the radiation surface of the main beam 30 having passed through the grating 3 becomes narrower in the direction of the surface perpendicular to the radiation surface at the light source. In other words, the grating 3 functions as a convex lens to narrow the spread of the radiation surface in the direction of the surface that is perpendicular to the radiation angle at the light source, which direction is in the direction b_{d}′. More concretely, the grating 3 is formed to function as a cylindrical convex lens in such a way that the grating 3 functions as a convex lens to narrow the spread of the radiation surface only with respect to the direction of the surface perpendicular to the radiation angle at the light source, which direction is perpendicular to the direction b_{d} of the grating grooves, but does not function with respect to the direction of the surface parallel to the radiation angle at the light source, which direction is parallel to the direction of the grating grooves b.

As described above, the grating surface of the grating 3 is formed such that, in the direction b_{d}′, the intensity distributions of the main beam 30 and the sub beams 31 and 32 are improved, and, at the same time, astigmatism in the main beam 30 having passed through the grating 3 is corrected. This significantly reduces aberration in the 0th-order diffracted light beam having passed through the grating 3. It thus becomes possible for the objective lens 5 to converge light beams to a spot that is similar in dimension to a spot to be formed in the case where there is no aberration.

Further, it is possible to employ a grating 3 that includes: grating grooves b formed on a surface of the grating 3; and a layer that is further provided on the surface and made of a material having a higher refractive index than that of the grating 3.

Concretely, it is possible to use glass as a material of the grating 3, and liquid crystal as the material (material having a higher refractive index) that has a higher refractive index than that of the grating 3. An exemplary grating in which the layer made of a material having a high refractive index is provided on the grating 3 is a composite grating in which the material having a high refractive index is sandwiched between the grating 3 and a sealing member made of the same material as that of the grating 3.

In this case, the composite grating including the layer made of a material having a high refractive index functions as a lens in the opposite manner to the case in which no layer made of a material having a high refractive index is provided. Concretely, the grating 3 formed as shown in FIG. 4 functions as a concave lens in the direction b_{d}′. On the other hand, the composite grating in which the layer made of a material having a high refractive index is provided on the grating 3 functions as a convex lens in the direction b_{d}′.

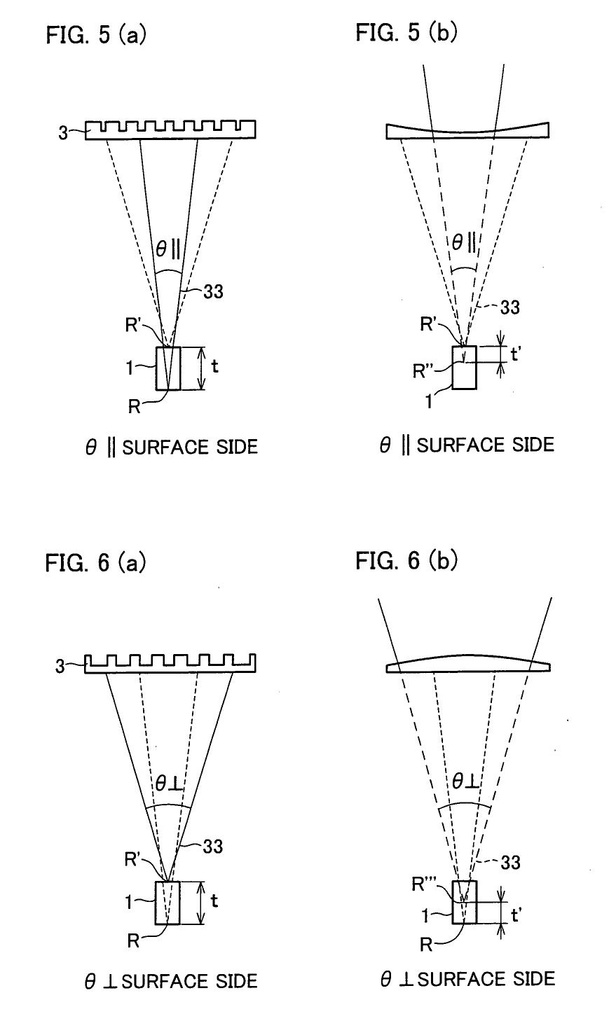

The grating 3 is designed such that it functions to make the intensity distribution the light beam 33 uniform and to cause astigmatism to be generated in a direction in which the astigmatism is allowed to offset astigmatism generated in the semiconductor laser 1. The following describes how the grating 3 corrects astigmatism in the light beam 33, with reference to FIGS. 5(a) to 8(b).

In FIGS. 5(a) to 8(b), the radiation angle in the direction of a surface parallel to a join surface of the laser chip in the semiconductor laser 1, is indicated as θ∥, and a radiation surface formed by the radiation angle is indicated as surface θ∥. In the same manner, the radiation angle in the direction of a surface perpendicular to the surface of the semiconductor laser 1, to which join surface the laser chip is joined, is indicated as θ⊥, and a radiation surface formed by the radiation angle is indicated as surface θ⊥.

FIGS. 5(a) and 5(b) are explanatory diagrams each explaining a state of a radiation surface of the light beam 33 that passes through the grating 3, in the case where the grating 3 that functions as a concave lens is employed. FIG. 5(a) shows virtual-source locations R and R′ before the light beam 33 passes through the grating 3. FIG. 5(b) shows virtual-source locations R″ and R′ after the light beam 33 passes through the grating 3.

FIGS. 6(a) and 6(b) are explanatory diagrams each explaining a state of a radiation surface of the light beam 33 that passes through a grating 3 having another structure, in the case where the grating 3 that functions as a convex lens is employed. FIG. 6(a) shows virtual-source location R and R′ before the light beam 33 passes through the grating 3. FIG. 6(b) shows virtual-source location R′″ and R′ after the light beam 33 passes through the grating 3.

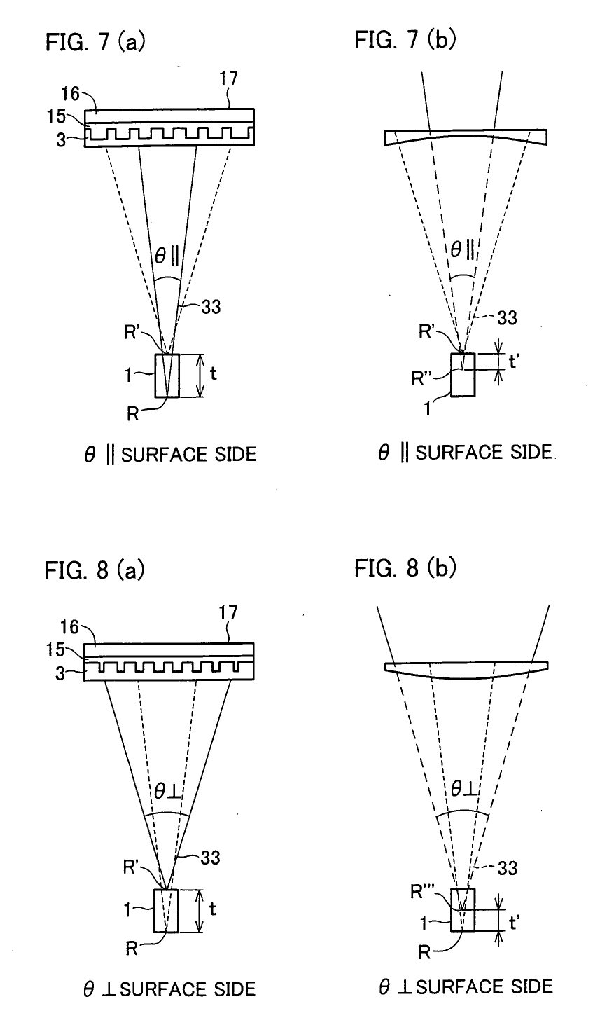

FIGS. 7(a) and 7(b) are explanatory diagrams each explaining a state of a radiation surface of the light beam 33 that passes through a composite grating 17, in the case where the composite grating 17 functions as a concave lens and is structured in such a way that the layer 15 made of a material having a high refractive index (layer made of a material having a higher refractive index than that of the grating) is sandwiched between the grating 3 and a sealing member 16 made of the same material as that of the grating 3. FIG. 7(a) shows virtual-source locations R and R′ before the light beam 33 passes through the composite grating 17. FIG. 7(b) shows virtual-source locations R″ and R′ after the light beam 33 passes through the composite grating 17.

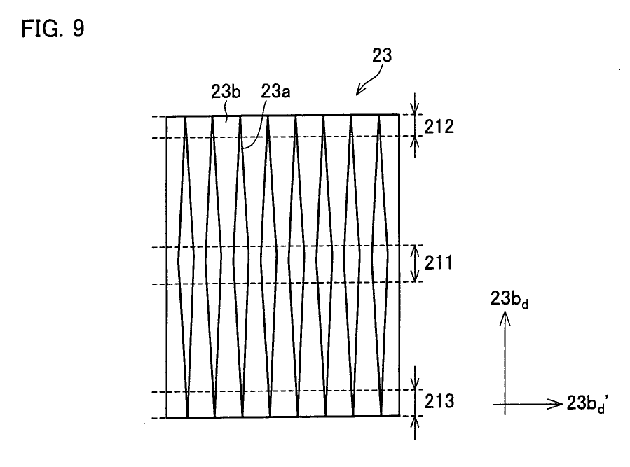

FIGS. 8(a) and 8(b) are explanatory diagrams each explaining a state of a radiation surface of the light beam 33 that passes through a composite grating 17 having another structure, in the case where the composite grating 17 functions as a convex lens and is structured such that the layer 15 made of a material having a high refractive index is sandwiched between the grating 3 and the sealing member 16 made of the same material as that of the grating 3. FIG. 8(a) shows virtual-source locations R and R′ before the light beam 33 passes through the composite grating 17. FIG. 8(b) shows virtual-source locations R′″ and R′ after the light beam 33 passes through the composite grating 17.

First, the following describes how the grating 3 that functions as a concave lens to corrects astigmatism in the light beam 33.

In this case, the grating 3 is placed in a manner such that it functions as a concave lens with respect to a surface of the light beam 33 emitted from the semiconductor laser 1, which surface is parallel to the radiation angle at the light source. In the instant description, the surface parallel to the radiation angle at the light source is a surface that is parallel to a sheet on which FIGS. 5(a) and 5(b) are presented, and the surface perpendicular to the radiation angle at the light source is a surface that is perpendicular to a sheet on which FIGS. 5(a) and 5(b) are presented. Further, the direction of the grating grooves of the grating 3 is perpendicular to the surface parallel to the radiation angle at the light source.

As shown in FIG. 5(a), the semiconductor laser 1 has a property that the spread of the radiation surface differs between a parallel surface and a perpendicular surface with respect to a direction in which a laser chip oscillating the light beam 33 is stacked. For this reason, the virtual-source location R in a parallel direction with respect to the direction in which the laser chip is stacked exists at the back of the virtual-source location R′ in a perpendicular direction (farther position from the grating 3). Thus, the semiconductor laser 1 includes an astigmatic difference t. In this case, the ratio of the grating grooves to the grating ridges in the grating 3 is set such that the ratio is 1 in the central area and approximates to 0 at greater distances from the central area toward a peripheral area in the direction perpendicular to the direction of the grating grooves.

As shown in FIG. 5(b), after the light beam 33 emitted from the semiconductor laser 1 passes through the grating 3, the spread of the radiation surface of the light beam becomes wider in the surface that is parallel to the radiation angle at the light source, which surface is perpendicular to the direction of the grating grooves of the grating 3. This causes the virtual-source location R, which is in the parallel direction to the direction in which the laser chip is stacked, is shifted forward to R″ (closer position to the grating 3). As a result, the astigmatic difference between the virtual-source location R″, which is in the direction of the surface parallel to the radiation angle at the light source, and the virtual-source location R′, which is in the direction of the surface perpendicular to the radiation angle at the light source, is reduced to t′. By this way, the astigmatism in the light beam 33 having passed through the grating 3 is corrected.

As the foregoing describes, the grating 3 functions to correct the astigmatism in the light beam 33. Specifically, the grating 3 functions as a concave lens to widen the spread of the radiation surface of the light beam 33, which radiation surface is the surface perpendicular to the direction of the grating grooves and parallel to the radiation angle at the light source. More concretely, the grating 3 functions as a cylindrical concave lens such that the grating 3 functions as a concave lens to widen the spread of the radiation surface only with respect to a surface of the light beam 33, which surface is perpendicular to the direction of the grating grooves and parallel to the radiation angle at the light source, but does not function with respect to a surface that is parallel to the direction of the grating grooves and perpendicular to the radiation angle at the light source.

Next, the following describes how the grating 3 that functions as a convex lens corrects astigmatism in the light beam 33, with reference to FIG. 6.

In this case, the grating 3 is placed in a manner such that it functions as a convex lens with respect to a surface of the light beam 33 emitted from the semiconductor laser 1, which surface is perpendicular to the radiation angle at the light source. In the instant description, the surface perpendicular to the radiation angle at the light source is a surface that is parallel to a sheet on which FIGS. 6(a) and 6(b) are presented, and the surface parallel to the radiation angle at the light source is a surface that is perpendicular to a sheet on which FIGS. 6(a) and 6(b) are presented. Further, the direction of the grating grooves of the grating 3 is perpendicular with respect to the surface perpendicular to the radiation angle at the light source.

As shown in FIG. 6(a), the semiconductor laser 1 includes the astigmatic difference t. For this reason, the virtual-source location R in the direction parallel to the direction in which the laser chip is stacked exists at the back of the virtual-source location R′ in the perpendicular direction (farther position from the grating 3). In this case, the grating grooves and the grating ridges of the grating 3 are formed in a manner such that the ratio of the grating grooves to the grating ridges is 1 in the central area and approximates to infinity at greater distances, in the direction perpendicular to the direction of the grating grooves, from the central area toward a peripheral area.

As shown in FIG. 6(b), after the light beam 33 emitted from the semiconductor laser 1 passes through the grating 3, the spread of the radiation surface of the light beam becomes narrower, which radiation surface is perpendicular to the direction of the grating grooves of the grating 3 and is perpendicular to the radiation angle at the light source. This causes the virtual-source location R′, which is in the direction perpendicular to the direction in which the laser chip is stacked, is shifted backward to R′″ (farther position from the grating 3). As a result, the astigmatic difference between the virtual-source location R, which is in the direction of the surface parallel to the radiation angle at the light source, and the virtual-source location R′″, which is in the direction of the surface perpendicular to the radiation angle at the light source, is reduced to t′. By this way, the astigmatism in the light beam 33 having passed through the grating 3 is corrected.

As the foregoing describes, the grating 3 functions to correct the astigmatism in the light beam 33. Specifically, the grating 3 functions as a convex lens to widen the spread of the radiation surface of the light beam 33, which radiation surface is perpendicular to the direction of the grating grooves and perpendicular to the radiation angle at the light source. More concretely, the grating 3 functions as a cylindrical concave lens such that the grating 3 functions as a convex lens to widen the spread of the radiation surface only with respect to a surface of the light beam 33, which surface is perpendicular to the direction of the grating grooves and perpendicular to the radiation angle at the light source, but does not function with respect to the surface that is parallel to the direction of the grating grooves and parallel to the radiation angle at the light source.

Next, the following describes how the composite grating 17 that functions as a concave lens and includes the layer 15 made of a material having a higher refractive index than that of the grating 3 corrects astigmatism in the light beam 33, with reference to FIG. 7.

In this case, the composite grating 17 is placed in a manner such that it functions as a concave lens with respect to a surface of the light beam 33 emitted from the semiconductor laser 1, which surface is parallel to the radiation angle at the light source. In the instant description, the surface parallel to the radiation angle at the light source is the surface that is parallel to a sheet on which FIGS. 7(a) and 7(b) are presented, and the surface perpendicular to the radiation angle at the light source is the surface that is perpendicular to a sheet on which FIGS. 7(a) and 7(b) are presented. Further, the direction of the grating grooves of the grating 3 is perpendicular with respect to the surface parallel to the radiation angle at the light source.

As shown in FIG. 7(a), the semiconductor laser 1 includes the astigmatic difference t. For this reason, the virtual-source location R in the direction parallel to the direction in which the laser chip is stacked exists at the back of the virtual-source location R′ in the perpendicular direction (farther position from the grating 3). In this case, the grating grooves and the grating ridges of the grating 3 are formed in a manner such that the ratio of the grating grooves to the grating ridges is 1 in the central area and approximates to 0 at greater distances, in a direction perpendicular to the direction of the grating grooves, from the central area toward a peripheral area.

As shown in FIG. 7(b), after the light beam 33 emitted from the semiconductor laser 1 passes through the composite grating 17, the spread of the radiation surface of the light beam becomes wider, which radiation surface is perpendicular to the direction of the grating grooves of the composite grating 17 and parallel to the radiation angle at the light source. This causes the virtual-source location R, which is in the direction parallel to the direction in which the laser chip is stacked, is shifted forward to R″ (closer position to the composite grating 17). As a result, the astigmatic difference between the virtual-source location R″, which is in the direction of the surface parallel to the radiation angle at the light source, and the virtual-source location R′, which is in the direction of the surface perpendicular to the radiation angle at the light source, is reduced to t′. By this way, the astigmatism in the light beam 33 having passed through the composite grating 17 is corrected.

As the foregoing describes, the composite grating 17 functions to correct the astigmatism in the light beam 33. Specifically, the composite grating 17 functions as a concave lens to widen the spread of the radiation surface of the light beam 33, which radiation surface is perpendicular to the direction of the grating grooves and parallel to the radiation angle at the light source. More concretely, the composite grating 17 functions as a cylindrical concave lens such that the composite grating 17 functions as a concave lens to widen the spread of the radiation surface only with respect to a surface of the light beam 33, which surface is perpendicular to the direction of the grating grooves and parallel to the radiation angle at the light source, but does not function with respect to the surface that is parallel to the direction of the grating grooves and perpendicular to the radiation angle at the light source.

Next, the following describes how the composite grating 17 that functions as a convex lens and includes the layer 15 made of a material having a higher refractive index than that of the grating 3 corrects astigmatism in the light beam 33, with reference to FIG. 8.

In this case, the composite grating 17 is placed in a manner such that it functions as a convex lens with respect to a surface of the light beam 33 emitted from the semiconductor laser 1, which surface is perpendicular to the radiation angle at the light source. In the instant description, the surface perpendicular to the radiation angle at the light source is a surface that is parallel to a sheet on which FIGS. 8(a) and 8(b) are presented, and the surface parallel to the radiation angle at the light source is a surface that is perpendicular to a sheet on which FIGS. 8(a) and 8(b) are presented. Further, the direction of the grating grooves of the grating 3 is perpendicular with respect to the surface perpendicular to the radiation angle at the light source.

As shown in FIG. 8(a), the semiconductor laser 1 includes the astigmatic difference t. For this reason, the virtual-source location R in the direction parallel to the direction in which the laser chip is stacked exists at the back of the virtual-source location R′ in the perpendicular direction (farther position from the grating 3). In this case, the grating grooves and the grating ridges of the grating 3 are formed in a manner such that the ratio of the grating grooves to the grating ridges is 1 in the central area and approximates to infinity at greater distances, in a direction perpendicular to the direction of the grating grooves, from the central area toward a peripheral area.

As shown in FIG. 8(b), after the light beam 33 emitted from the semiconductor laser 1 passes through the composite grating 17, the spread of the radiation surface of the light beam becomes narrower, which radiation surface is perpendicular to the direction of the grating grooves of the composite grating 17 and perpendicular to the radiation angle at the light source. This causes the virtual-source location R′, which is in the direction perpendicular to the direction in which the laser chip is stacked, is shifted backward to R′″ (farther position from the composite grating 17). As a result, the astigmatic difference between the virtual-source location R, which is in the direction of the surface parallel to the radiation angle at the light source, and the virtual-source location R′″, which is in the direction of the surface perpendicular to the radiation angle at the light source, is reduced to t′. By this way, the astigmatism in the light beam 33 having passed through the composite grating 17 is corrected.

As the foregoing describes, the composite grating 17 functions to correct the astigmatism in the light beam 33. Specifically, the composite grating 17 functions as a convex lens to widen the spread of the radiation surface of the light beam 33, which radiation surface is perpendicular to the direction of the grating grooves and is perpendicular to the radiation angle at the light source. More concretely, the composite grating 17 functions as a cylindrical concave lens such that the composite grating 17 functions as a convex lens to widen the spread of the radiation surface only with respect to a surface of the light beam 33, which surface is perpendicular to the direction of the grating grooves and perpendicular to the radiation angle at the light source, but does not function with respect to a surface that is parallel to the direction of the grating grooves and parallel to the radiation angle at the light source.

In the instant description, a grating 3 including grating grooves and grating ridges is employed, which grating grooves and grating ridges are formed in a manner such that the ratio of the width of the grating grooves to the width of the grating ridges is changed in the direction perpendicular to the direction of the grating grooves. It is, however, also possible to employ a grating 3 including grating grooves and grating ridges that are formed in a manner such that the ratio of the width of the grating grooves to the width of the grating ridges is changed in the direction of the grating grooves. Further, it is also possible to employ a grating 3 including grating grooves and grating ridges that are formed in a manner such that the ratio of the width of the grating grooves to the width of the grating ridges is changed in the direction of the grating grooves, and at the same time, in the direction perpendicular to the direction of the grating grooves.

### Embodiment 2

The following describes in detail Embodiment 2 of the present invention, with reference to FIG. 9. Components that are same as those in the Embodiment described above are given the same reference numerals, and description thereof is omitted.

An optical pickup apparatus is produced in the same structure as that described in Embodiment 1, except that a grating 23 is employed in place of the grating 3.

The following describes a concrete configuration of the grating 23, with reference to FIG. 9. FIG. 9 is a plan view of the concrete configuration of the grating 23, showing a configuration of a grating surface of the grating. Reference numerals 23a and 23b are given to grating ridges and grating grooves, respectively. Further, reference numerals 23a_{w} and 23b_{w} are given to a width of the grating ridges 23a and a width of the grating grooves 23b, respectively.

The grating 23 is, for example, a relief grating formed with a predetermined pitch on a glass substrate. By gently changing, as shown in FIG. 9, the width of the grating grooves 23b_{w} or the depth of the grating grooves in the direction 23b_{d} of the grating grooves, it is possible to make the diffraction efficiency gently decrease from the center along the direction 23b_{d} of the grating grooves in the distribution.

As shown in FIG. 9, the grating surface of the grating 23 includes the grating ridges 23a having the width 23a_{w} and the grating grooves 23b having the width 23b_{w}. The grating 23 is placed in a manner such that the direction 23b_{d} of the grating grooves becomes parallel with respect to the direction of a surface (radiation surface with a wide spread from the light source) that is perpendicular to the radiation angle of a light beam emitted from the semiconductor laser 1.

The grating grooves 23b are formed in the direction 23b_{d} of the grating grooves on the grating surface of the grating 23. As shown in FIG. 9, the grating ridges 23a extend from the central area 211 toward the peripheral areas 212 and 213 in such a way that the width 23a_{w} gently decreases. Specifically, the grating ridges 23a and the grating grooves 23b of the grating 23 are formed in a manner such that 23a_{w}/23b_{w} approximates to 1 in the central area 211 and approximates to 0 in the peripheral areas 212 and 213. In other words, the grating ridges 23a and the grating grooves 23b of the grating 23 are formed in a manner such that 23a_{w}/23b_{w} approximates to 0 at greater distances from the central area 211 toward the peripheral areas 212 and 213. In this case, the light-intensity distribution of the main beam 30 becomes closer to flat, in the direction in which 23a_{w}/23b_{w} is to be changed, i.e. in a direction 23b_{d}′. Thereafter, the main beam 30 enters the objective lens 5. By this way, it becomes possible in the direction 23b_{d} to narrow a spot on the optical disk 6 so that the spot becomes smaller.

The spread of the radiation surface of the main beam 30 having passed through the grating 23 becomes narrower in the direction of the surface perpendicular to the radiation angle at the light source. In other words, the grating 23 functions as a convex lens that narrows the spread of the radiation surface, in the direction parallel to the direction 23b_{d} of the grating grooves and in the direction of the surface perpendicular to the radiation angle at the light source. More concretely, the grating 23 is formed to function as a cylindrical convex lens in such a way that the grating 23 functions as a convex lens to narrow the spread of the radiation surface of the light beam only with respect to the direction of the surface perpendicular to the radiation angle at the light source, which direction is parallel to the direction of the grating grooves 23b, but does not function with respect to the direction of the surface (radiation surface with a narrow spread from the light source) that is parallel to the radiation angle of the light beam, which direction is perpendicular to the direction of the grating grooves 23b.

As described above, the grating surface of the grating 23 is formed in a manner such that, in the direction 23b_{d}, the intensity distributions of the main beam 30 and the sub beams 31 and 32 are improved, and, at the same time, astigmatism in the main beam 30 that passes through the grating 23 is corrected. This significantly reduces aberration in the 0th-order diffracted light beam having passed through the grating 23. It thus becomes possible for the objective lens 5 to converge light beams to a spot that is similar in dimension to a spot to be formed in the case where there is no aberration.

As the foregoing describes, in the case where the narrow spread of the radiation surface at the light source is parallel to the direction 23b_{d} of the grating grooves, the grating surface of the grating 23 is produced in such a way that the ratio 23a/23b of the grating ridges 23a to the grating grooves 23b is changed from 1 to 0 at greater distances, in the direction 23b_{d}′ of the grating grooves, from the central area 211.

Further, it is also possible to place the grating 23 in such a way that the direction 23b_{d} of the grating grooves becomes perpendicular to the direction of the surface that is perpendicular to the radiation angle of the semiconductor laser 1.

In this case, it is possible to produce the grating surface of the grating 23 in such a way that the ratio 23a/23b of the grating ridges 23a to the grating grooves 23b is changed from 1 to infinity at greater distances, in the direction 23b_{d} of the grating grooves, from the central area 211. This causes the light-intensity distribution of the main beam 30 to become closer to flat, in the direction 23b_{d} of the grating grooves, and then enters the objective lens 5. By this way, it becomes possible in the direction 23b_{d} of the grating grooves to narrow a spot on the optical disk 6 so that the spot becomes smaller.

The spread of the radiation surface of the main beam 30 having passed through the grating 23 becomes wider in the direction of the surface parallel to the radiation surface at the light source. In other words, the grating 23 functions as a concave lens that widens the spread of the radiation surface, in the direction of a surface parallel to the radiation angle at the light source, which direction is in the direction 23b_{d} of the grating grooves. More concretely, the grating 23 is formed to function as a cylindrical concave lens with respect to a light beam in such a way that the grating 23 functions as a concave lens to widen only the spread of the radiation surface in the direction of the surface parallel to the radiation angle at the light source, which direction is parallel to the direction 23b_{d} of the grating grooves, but does not function with respect to the direction of the surface perpendicular to the radiation angle at the light source, which direction is parallel to the direction of the grating grooves 23b.

As described above, the grating surface of the grating 23 is formed in a manner such that, in the direction 23b_{d} of the grating grooves, the intensity distributions of the main beam 30 and the sub beams 31 and 32 are improved, and astigmatism in the main beam 30 that passes through the grating 23 is corrected. This significantly reduces aberration in the 0th-order diffracted light beam having passed through the grating 23. It thus becomes possible for the objective lens 5 to converge light beams to a spot that is similar in dimension to a spot to be formed in the case where there is no aberration.

Further, it is possible to employ a grating 23 including: grating grooves 23b formed on a surface of the grating 23; and a layer that is further provided on the surface and made of a material having a higher refractive index than that of the grating 23.

Concretely, it is possible to use glass as a material of the grating 23, and liquid crystal as a material (material having a higher refractive index) that has a higher refractive index than that of the grating 23. An exemplary grating that is structured in a manner such that the layer made of a material having a high refractive index is provided on the grating 23 is a composite grating that is structured in a manner such that a material having a high refractive index is sandwiched between the grating 23 and a sealing member made of the same material as that of the grating 23.

In this case, the composite grating functions as a lens in the opposite manner to the case where no layer made of a material having a high refractive index is provided. Concretely, the grating 23 formed as shown in FIG. 9 functions as a convex lens in the direction 23b_{d} of the grating grooves, whereas the composite grating in which the layer made of a material having a high refractive index is provided on the grating 23 functions as a concave lens in the direction 23b_{d} of the grating grooves.

The grating 23 is designed in a manner such that it functions to make the intensity distribution of the light beam uniform and, at the same time, to cause an astigmatism to be generated such that the astigmatism offsets an astigmatism caused by the semiconductor laser 1. How the grating 23 corrects astigmatism in the light beam is already described in Embodiment 1, and therefore the description is omitted in the present embodiment.

### Embodiment 3

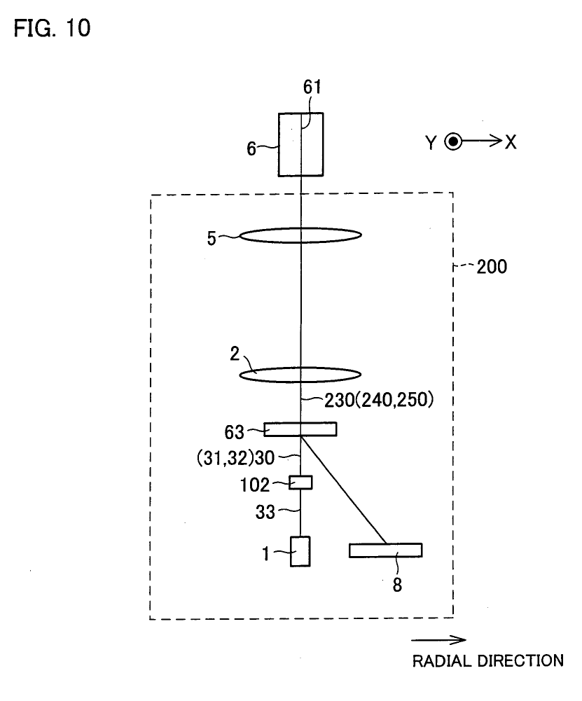

The following describes in detail Embodiment 3 of the present invention, with reference to FIGS. 10 to 12. Components that are same as those in the Embodiment described above are given the same reference numerals, and description thereof is omitted.

FIG. 10 is a sectional view illustrating a schematic structure of an optical pickup apparatus 200 of the present invention. The optical pickup apparatus 200, as shown in FIG. 10, includes a semiconductor laser (light source) 1, a first grating 102, a second grating (grating) 63, a collimator lens 2, an objective lens (light converging means) 5, and a light receiving device 8.

The first grating 102 splits the light beam 33 having entered the grating 102 into three diffracted light beams, a 0th-order diffracted light beam and ±1st-order diffracted light beams, and then guides the three diffracted light beams to the objective lens 5. The present embodiment employs, as the first grating 102, an ordinary grating including grating ridges and grating grooves that are formed in a manner such that the ratio of a width of the grating ridges to a width of the grating grooves is the same all over the surface. The first grating 102 is placed in a manner such that the direction of the grating grooves becomes parallel to the direction of a surface (radiation surface with a narrow spread from the light source) that is parallel to the radiation angle at the light source.

The second grating 63 allows a light beam coming from the semiconductor laser 1 to pass therethrough. Further, the second grating 63 diffracts a reflected light beam having been reflected by the optical disk (storage medium) 6 so that the reflected light beam is guided to the light receiving device 8. A concrete structure of the second grating 63 will be described below.

After emitted from the semiconductor laser 1, the light beam 33 enters the first grating 102, is split into a main beam (0th-order diffracted light beam) 30, a sub beam (+1st-order diffracted light beam) 31, and a sub beam (−1st-order diffracted light beam) 32. Then, the main beam 30 and the sub beams 31 and 32 enter the second grating 63, and are respectively split, by the second grating 63, into a 0th-order diffracted light beam 230, a 0th-order diffracted light beam 240, a 0th-order diffracted light beam 250, a +1st-order diffracted light beam (not illustrated), and a −1st-order diffracted light beam (not illustrated). At this time, the ±1st order diffracted light beams generated in the second grating 63 are cut at an aperture and therefore do not enter the collimator lens 2. After passing through the second grating 63, the light beam (main beam 230, sub beam 240, and sub beam 250) enters the collimator lens 2, and is changed to parallel light. Thereafter, the objective lens 5 converges the light beam to a track 61 at the optical disk (storage medium) 6. After converged to the track 61 at the optical disk 6, the light beam, in three separate light beams of the main beam 230 and the sub beams 240 and 250, is reflected so that the light beam becomes a reflected light beam.

After reflected by the optical disk 6, the reflected light beam passes through the objective lens 5 and then through the collimator lens 2. Thereafter, the reflected light beam is diffracted by the second grating 63. The second grating 63 is constituted of two areas that are different from each other in grating pitch. After entering the second grating 63, three light beams, the main beam 230 and the sub beams 231 and 232, are respectively split into two so that the three light beams become six light beams. Then, the six light beams are guided to the light receiving device 8.

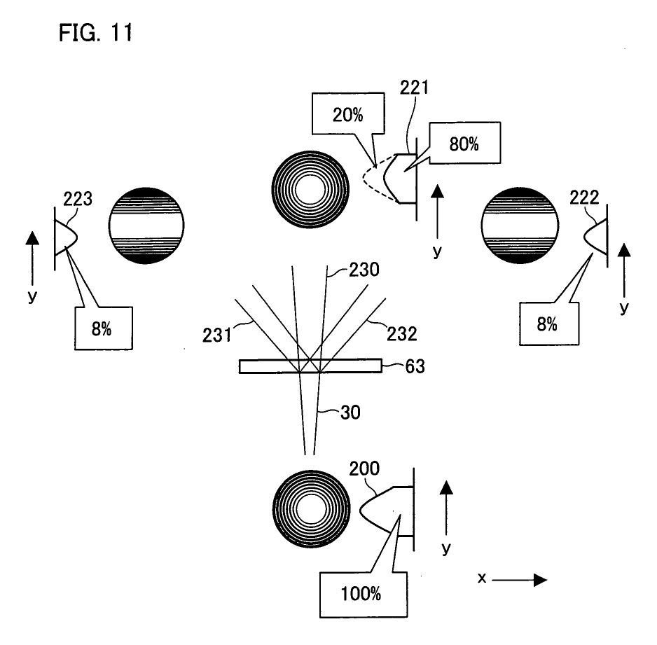

The following describes action of the second grating 63 with respect to light intensity, with reference to FIG. 11.

FIG. 11 is an explanatory diagram for explaining how a light beam is diffracted when passing through the second grating 63 in the optical pickup apparatus 200. Note that, although FIG. 11 shows the second grating 63 that causes the 0th-order diffracted light beam 31 having passed through the first grating 102 to be split, by the light-quantity ratio of 1:10:1=−1st-order diffracted light beam: 0th-order diffracted light beam: +1st-order diffracted light beam, into a −1st-order diffracted light beam, a 0th-order diffracted light beam, and a +1st-order diffracted light beam, the light-quantity ratio, by which the second grating 63 diffracts light, is not limited to the above ratio. Further, note that in the present embodiment, a direction (hereinafter, radial direction) that corresponds to a radial direction of the optical disk 6 is named a direction x, and a direction (hereinafter, track direction) that is orthogonal to the radial direction, i.e. a length direction of the track at the optical disk 6, is named a direction y.

As shown in FIG. 11, in the case where the second grating 63 causes the light beam to be split, by the light-quantity ratio of 1:10:1, into a −1st-order diffracted light beam, a 0th-order diffracted light beam, and a +1st-order diffracted light beam, diffraction efficiency of the second grating 63 is −1st-order diffracted light beam: 0th-order diffracted light beam: +1st-order diffracted light beam=8%: 80%: 8%. Further, the remaining 4% of the diffraction efficiency of the second grating 63 becomes diffraction efficiency of ±second or higher order diffracted light beams.

An intensity distribution 220, which is a Gaussian intensity distribution, in FIG. 11 shows a distribution of intensity in the direction y of the 0th-order diffracted light beam having passed through the first grating 102. When passing through the second grating 63, the 0th-order diffracted light beam is split into a main beam 230, which is a 0th-order diffracted light beam, and a pair of sub beams 231 and 232, which pair is a pair of ±1st-order diffracted light beams. A distribution of intensity in the direction y of the 0th-order diffracted light beam having outgone from the second grating 63 is as shown in an intensity distribution 221. The intensity distribution 221 of the main beam 230 is a uniform intensity distribution in which the vicinity of the optical axis is cut. The quantity of light that is cut in the vicinity of the optical axis in the intensity distribution 221 is 20% of the entire light quantity of the 0th-order diffracted light beam 30 having passed through the first grating 102. As the foregoing describes, the second grating 63 causes the 0th-order diffracted light beam 30 to change so that the 0th-order diffracted light beam 30 becomes a 0th-order diffracted light beam whose intensity distribution is uniform and closer to flat.

On the other hand, 16% of the entire light quantity of the 0th-order diffracted light beam 30 having passed through the first grating 102 and having been diffracted in 0th-order is changed to the sub beam 231 and the sub beam 232. Specifically, each light quantity of the sub beam 231 and the sub beam 232 is 8% of the entire light quantity of the 0th-order diffracted light beam 30 having passed through the first grating 102 and having been diffracted in 0th-order. Further, as shown in FIG. 11, distributions of intensities in the direction y of the sub beams 231 and 232 become as shown in an intensity distribution 223 and an intensity distribution 222, respectively. In each of the distributions, the intensity gently decreases at greater distances, in the direction y, from the vicinity of the optical axis.

Accordingly, the second grating 63 functions to improve the respective intensity distributions of the main beam 230, the sub beam 231, and the sub beam 232. Specifically, the second grating 63 functions in a manner such that, with respect to the main beam 230, the distribution of intensity in the direction y becomes uniform and closer to flat, and, with respect to the sub beam 231 and the sub beam 232, the distribution of intensity in the direction y decreases at greater distances, in the direction y, from the vicinity of the optical axis. In other words, the second grating 63 functions to improve Rim intensity of each of the main beam 230, the sub beam 231, and the sub beam 232. More specifically, the second grating 63 functions to increase Rim intensity, in the direction y, of the main beam 230 and to decrease Rim intensities, in the direction y, of the respective sub beams 231 and 232. The “Rim intensity” indicates a ratio of light intensity of a luminous flux that passes through an outer edge area of the objective lens, with respect to light intensity of a luminous flux that passes through the central area of the objective lens 5.

The second grating 63 is formed so as to improve the respective distributions of intensities, in the direction y, of the main beam 230 and the sub beams 231 and 232. The second grating 63, however, is not limited to this configuration. It is also possible for the second grating 63 to be formed in a manner such that distributions of intensities in the direction x are improved.

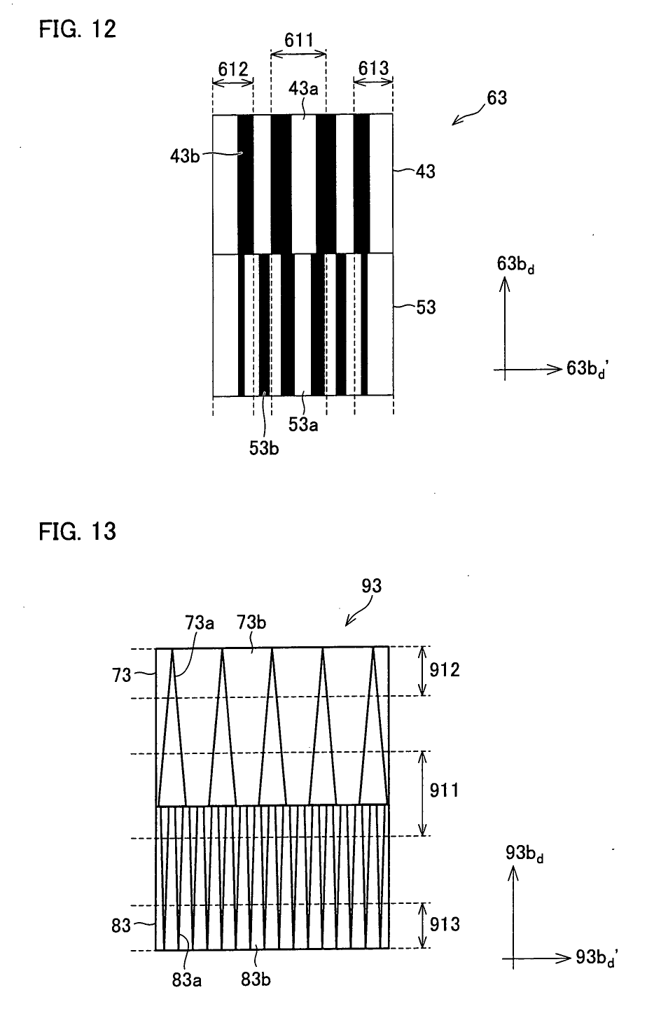

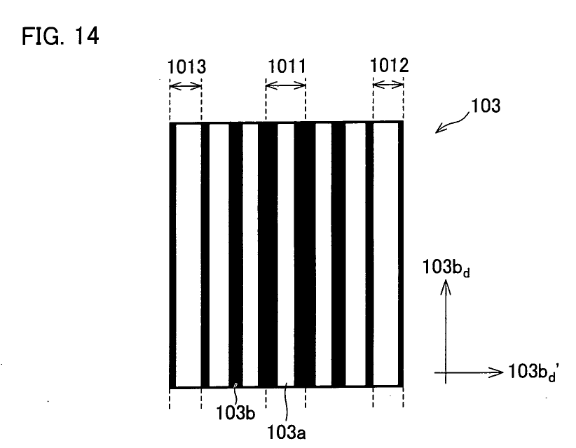

The following describes a configuration of the grating surface of the second grating 63 of the optical pickup apparatus 200, with reference to FIG. 12. FIG. 12 is a plan view illustrating a concrete configuration of the second grating 63.

As shown in FIG. 12, two grating surfaces 43 and 53 are formed on the grating surface of the second grating 63. The grating surfaces 43 and 53 are different from each other in grating pitch. The grating grooves of the grating surfaces are in the same direction. Further, the grating surfaces 43 and 53 join along a side edge that is parallel to the direction of the grating grooves of the grating surfaces 43 and 53.

Reference numerals 43a and 43b are given to the grating ridges and the grating grooves of the grating surface 43, respectively, which grating surface 43 is wider in the grating pitch. Further, reference numerals 53a and 53b are given to the grating ridges and the grating grooves of the grating surface 53, respectively, which grating surface 53 is narrower in the grating pitch. Further, reference numerals 43a_{w} and 53a_{w} are given to a width of the grating ridges 43a and a width of the grating ridges 53a, respectively. Further, reference numerals 43b_{w} and 53b_{w} are given to a width of the grating grooves 43b and a width of the grating grooves 53b, respectively.

The second grating 63 is, for example, a relief grating formed with a predetermined pitch on a glass substrate. The second grating 63 is formed with two grating surfaces: the grating surface 43 formed of the grating ridges 43a each having the width 43a_{w} and the grating grooves 43b each having the width 43b_{w}; and the grating surface 53 formed of the grating ridges 53a each having the width 53a_{w} and the grating grooves 53b each having the width 53b_{w}.

By gently changing, as shown in FIG. 12, the width of the grating grooves or the depth of the grating grooves in the direction 63b_{d}′, which is perpendicular to the direction b_{d} of the grating grooves, it is possible to make the diffraction efficiency gently decrease from the center along the direction 63b_{d}′ in the distribution.

The second grating 63 is formed in a manner such that the direction 63b_{d} of the grating grooves becomes perpendicular to a direction of a surface (radiation surface with a narrow spread from the light source) that is parallel to the radiation angle at the light source.

The grating grooves 43b and 53b are formed in the direction 63b_{d} of the grating grooves on the grating surface of the second grating 63. In the direction 63b_{d}′, the grating ridges 43a, the grating ridges 53a, the grating grooves 43b, and the grating grooves 53b of the second grating 63 are formed in a manner such that respective 43a_{w}/43b_{w} and 53a_{w}/53b_{w} approximate to 1 in a central area 611, and approximate to infinity in peripheral areas 612 and 613. In other words, the grating ridges 43a, the grating ridges 53a, the grating grooves 43b, and the grating grooves 53b of the second grating 63 are formed in a manner such that respective 43a_{w}/43b_{w} and 53a_{w}/53b_{w} approximate to infinity at greater distances from the central area 611 toward the peripheral areas 612 and 613. In this case, the light-intensity distribution of the main beam 230 becomes closer to flat, in the direction in which 43a_{w}/43b_{w} and 53a_{w}/53b_{w} are to be changed, i.e. the direction 63b_{d}′. Thereafter, the main beam 230 enters the objective lens 5. By this way, it becomes possible in the direction 63b_{d}′ to narrow a spot on the optical disk 6 so that the spot becomes smaller.

The spread of the radiation surface of the main beam 230 having passed through the second grating 63 becomes wider in the direction of the surface parallel to the radiation angle at the light source. In other words, the second grating 63 functions as a concave lens that widens the spread of the radiation surface, in the direction of the surface parallel to the radiation angle at the light source, which direction is in the direction 63b_{d}′. More concretely, the second grating 63 is formed to function as a cylindrical concave lens in such a way that the second grating 63 functions as a concave lens to widen the spread of the radiation surface only with respect to the direction of the surface parallel to the radiation angle at the light source, which direction is perpendicular to the direction 63b_{d} of the grating grooves, but does not function with respect to the direction of the surface (radiation surface with a wide spread from the light source) that is perpendicular to the radiation angle at the light source, which direction is parallel to the direction 63b_{d} of the grating grooves.

As described above, the grating surface of the second grating 63 is formed in a manner such that, in the direction 63b_{d}′, the intensity distributions of the main beam 230 and the sub beams 231 and 232 are improved, and, at the same time, astigmatism in the main beam 230 that passes through the second grating 63 is corrected. This significantly reduces aberration in the 0th-order diffracted light beam having passed through the second grating 63. It thus becomes possible for the objective lens 5 to converge light beams to a spot that is similar in dimension to a spot to be formed in the case where there is no aberration.

As the foregoing describes, in the case where the radiation surface with the wide spread from the light source is in the direction 63b_{d}′, the grating surface of the second grating 63 is produced in a manner such that respective ratios 43a_{w}/43b_{w} and 53a_{w}/53b_{w} of the widths of the grating ridges 43a, the grating ridges 53a, the grating grooves 43b, and the grating grooves 53b are changed from 1 to infinity at greater distances, in the direction 63b_{d}′, from the central area 611.

Further, it is also possible to place the second grating 63 in such a way that the direction 63b_{d} of the grating grooves becomes perpendicular to the direction of the surface that is perpendicular to the radiation angle at the semiconductor laser 1.

In this case, the grating surface of the second grating 63 is produced in a manner such that respective ratios 43a_{w}/43b_{w} and 53a_{w}/53b_{w} of the widths of the grating ridges 43a, the grating ridges 53a, the grating grooves 43b, and the grating grooves 53b are changed from 1 to 0 at greater distances, in the direction 63b_{d}′, from the central area 611. This causes, in the same manner as the second grating 63, the light-intensity distribution of the main beam 230 to become closer to flat, in the direction 63b_{d}′. Thereafter, the main beam 230 enters the objective lens 5. By this way, it becomes possible in the direction 63b_{d}′ to narrow a spot on the optical disk 6 so that the spot becomes smaller.

The spread of the radiation surface of the main beam 230 having passed through the second grating 63 becomes narrower in the direction of the surface perpendicular to the radiation surface at the light source. In other words, the second grating 63 functions as a convex lens that narrows the spread of the radiation surface, in the direction of the surface perpendicular to the radiation angle at the light source, which direction is in the direction 63b_{d}′. More concretely, the second grating 63 is formed to function as a cylindrical convex lens with respect to a light beam in such a way that the second grating 63 functions as a convex lens to narrow the spread of the radiation surface in the direction of the surface perpendicular to the direction of the surface perpendicular to the radiation angle at the light source, which direction is perpendicular to the direction 63b_{d} of the grating grooves, but does not function with respect to the direction of the surface parallel to the radiation angle at the light source, which direction is parallel to the direction of the grating grooves 63b.

As described above, the grating surface of the second grating 63 is formed in a manner such that, in the direction 63b_{d}′, the intensity distributions of the main beam 230 and the sub beams 231 and 232 are improved, and astigmatism in the main beam 230 that passes through the second grating 63 is corrected. This significantly reduces aberration in the 0th-order diffracted light beam having passed through the second grating 63. It thus becomes possible for the objective lens 5 to converge light beams to a spot that is similar in dimension to a spot to be formed in the case where there is no aberration.

Further, it is possible to employ a second grating 63 including: grating grooves 43b and 53b formed on a surface of the second grating 63; and a layer that is further provided on the surface and made of a material having a higher refractive index than that of the second grating 63.

Concretely, it is possible to use glass as a material of the second grating 63, and liquid crystal as a material (material having a higher refractive index) that has a higher refractive index than that of the grating. An exemplary grating that is structured in a manner such that the layer made of a material having a high refractive index is provided on the second grating 63 is a composite grating that is structured in a manner such that a material having a high refractive index is sandwiched between the second grating 63 and a sealing member made of the same material as that of the second grating 63.

In this case, the composite grating functions as a lens in the opposite manner to the case where no layer made of a material having a high refractive index is provided. Concretely, the second grating 63 formed as shown in FIG. 12 functions as a concave lens in the direction 63b_{d}′, whereas the composite grating in which the layer made of a material having a high refractive index is provided on the second grating 63 functions as a convex lens in the direction 63b_{d}′.

The second grating 63 is designed in a manner such that it functions to make the intensity distribution of the light beam uniform and, at the same time, to cause an astigmatism to be generated in a manner such that the astigmatism offsets an astigmatism caused by the semiconductor laser 1. How the second grating 63 corrects astigmatism in the light beam is already described in Embodiment 1, and therefore the description is omitted in the present embodiment.

### Embodiment 4

The following describes in detail Embodiment 4 of the present invention, with reference to FIG. 13. Components that are same as those in the Embodiment described above are given the same reference numerals, and description thereof is omitted.

An optical pickup apparatus is produced in the same structure as that described in Embodiment 3, except that a grating 93 is employed in place of the second grating 63.

The following describes a concrete configuration of the grating 93, with reference to FIG. 13. FIG. 13 is a plan view illustrating the concrete configuration of the grating 93.

As shown in FIG. 13, two grating surfaces 73 and 83 are formed on the grating surface of the grating 93. The grating surfaces 73 and 83 are different from each other in the grating pitch. The grating grooves of the grating surfaces are in the same direction. The grating surfaces meet at a side edge thereof that is perpendicular to the direction of the grating grooves. Further, the respective grating ridges of those two grating surfaces 73 and 83 are formed to extend in a manner such that the widths of the grating ridges gently decrease at greater distances from the central area 911, which is in the vicinity of a tangential line of those two grating surfaces, toward the peripheral areas 912 and 913.

Reference numerals 73a and 73b are given to the grating ridges and the grating grooves of the grating surface 73, respectively, which grating surface 73 is wider in the grating pitch. Further, reference numerals 83a and 83b are given to the grating ridges and the grating grooves of the grating surface 83, respectively, which grating surface 83 is narrower in the grating pitch. Further, reference numerals 73a_{w} and 83a_{w} are given to a width of the grating ridges 73a and a width of the grating ridges 83a, respectively. Further, reference numerals 73b_{w} and 83b_{w} are given to a width of the grating grooves 73b and a width of the grating grooves 83b, respectively.

The grating 93 is, for example, a relief grating formed with a predetermined pitch on a glass substrate. By gently changing, as shown in FIG. 13, the widths 73b_{w} and 83b_{w} or the depth of the grating grooves in the direction 93b_{d} of the grating grooves, it is possible to make the diffraction efficiency gently decrease from the center along the direction 93b_{d} in the distribution.

As shown in FIG. 13, the grating surface of the grating 93 is formed of: a grating surface 73 that includes the grating ridges 73a each having the width 73a_{w} and the grating grooves 73b each having the width 73b_{w}; and a grating surface 83 that includes the grating ridges 83a each having the width 83a_{w} and the grating grooves 83b each having the width 83b_{w}. The grating 93 is placed in a manner such that the direction 93b_{d} of the grating grooves becomes parallel to the direction of the surface (radiation surface with a wide spread from the light source) that is perpendicular to the radiation angle of a light beam emitted from the semiconductor laser 1.

The grating grooves 73b and the grating grooves 83b are formed in the direction 93b_{d} of the grating grooves on the grating surface of the grating 93. As shown in FIG. 13, the grating ridges 73a and the grating ridges 83a extend from the central area 911 toward the peripheral areas 912 and 913 in such a way that the width 73a_{w} and the width 83a_{w} gently decreases. Specifically, the grating ridges 73a, the grating ridges 83a, the grating grooves 73b, and the grating grooves 83b of the grating 93 are formed in a manner such that, in the direction 93b_{d} of the grating grooves, respective 73a_{w}/73b_{w} and 83a_{w}/83b_{w} approximate to 1 in the central area 911 and approximate to 0 in the peripheral areas 912 and 913. In other words, the grating ridges 73a, the grating ridges 83a, the grating grooves 73b, and the grating grooves 83b of the grating 93 are formed in a manner such that respective 73a_{w}/73b_{w} and 83a_{w}/83b_{w} approximate to 0 at greater distances from the central area 911 toward the peripheral areas 912 and 913. In this case, the light-intensity distribution of the main beam 230 becomes closer to flat, in the direction in which 73a_{w}/73b_{w} and 83a_{w}/83b_{w} are to be changed, i.e. the direction 93b_{d} of the grating grooves. Thereafter, the main beam 230 enters the objective lens 5. By this way, it becomes possible in the direction 93b_{d} of the grating grooves to narrow a spot on the optical disk 6 so that the spot becomes smaller.

The spread of the radiation surface of the main beam 930 having passed through the grating 93 becomes narrower in the direction of the surface perpendicular to the radiation angle at the light source. In other words, the grating 93 functions as a convex lens that narrows the spread of the radiation surface, in the direction of the surface perpendicular to the radiation angle at the light source, which direction is in the direction 93b_{d} of the grating grooves. More concretely, the grating 93 is formed to function as a cylindrical convex lens with respect to a light beam in such a way that the grating 93 functions as a convex lens to narrow the spread of the radiation surface only with respect to the direction of the surface perpendicular to the radiation angle at the light source, which direction is parallel to the direction of the grating grooves 73b and the grating grooves 83b, but does not function with respect to the direction of the surface (radiation surface with a narrow spread from the light source) that is parallel to the radiation angle at the light source, which direction is perpendicular to the direction of the grating grooves 73b and the grating grooves 83b.

As described above, the grating surface of the grating 93 is formed in a manner such that, in the direction 93b_{d} of the grating grooves, the intensity distributions of the main beam 230 and the sub beams 231 and 232 are improved, and, at the same time, astigmatism in the main beam 230 that passes through the grating 93 is corrected. This significantly reduces aberration in the 0th-order diffracted light beam having passed through the grating 93. It thus becomes possible for the objective lens 5 to converge light beams to a spot that is similar in dimension to a spot to be formed in the case where there is no aberration.

As the foregoing describes, in the case where the wide spread of the radiation surface at the light source is in the direction 93b_{d} of the grating grooves, the grating surface of the grating 93 is produced in a manner such that the respective ratios 73a_{w}/73b_{w} and 83a_{w}/83b_{w} of the widths of the grating ridges 73a, the grating ridges 83a, the grating grooves 73b, and the grating grooves 83b are changed from 1 to 0 at greater distances, in the direction 93b_{d} of the grating grooves, from the central area 911.

Further, it is also possible to place the grating 93 in such a way that the direction 93b_{d} of the grating grooves becomes parallel to the direction of the surface parallel to the radiation angle of the semiconductor laser 1.

In this case, it is possible to produce the grating surface of the grating 93 in such a way that the respective ratios 73a_{w}/73b_{w} and 83a_{w}/83b_{w} of the widths of the grating ridges 73a, the grating ridges 83a, the grating grooves 73b, and the grating grooves 83b are changed from 1 to infinity at greater distances, in the direction 93b_{d} of the grating grooves, from the central area 911. This causes the light-intensity distribution of the main beam 230 to become closer to flat, in the direction 93b_{d} of the grating grooves. Thereafter, the main beam 230 enters the objective lens 5. By this way, it becomes possible in the direction 93b_{d} of the grating grooves to narrow a spot on the optical disk 6 so that the spot becomes smaller.

The spread of the radiation surface of the main beam 230 having passed through the grating 93 becomes wider in the direction of the surface parallel to the radiation surface at the light source. In other words, the grating 93 functions as a concave lens that widens the spread of the radiation surface, in the direction of the surface parallel to the radiation angle at the light source, which direction is in the direction 93b_{d} of the grating grooves. More concretely, the grating 93 is formed to function as a cylindrical concave lens with respect to a light beam in such a way that the grating 23 functions as a concave lens to widen the spread of the radiation surface only with respect to the direction of the surface parallel to the radiation angle at the light source, which direction is parallel to the direction 93b_{d} of the grating grooves, but does not function with respect to the direction of the surface perpendicular to the radiation angle at the light source, which direction is perpendicular to the direction of the grating grooves 93b.

As described above, the grating surface of the grating 93 is formed in a manner such that, in the direction 93b_{d} of the grating grooves, the intensity distributions of the main beam 230 and the sub beams 231 and 232 are improved, and, at the same time, astigmatism in the main beam 230 that passes through the grating 93 is corrected. This significantly reduces aberration in the 0th-order diffracted light beam having passed through the grating 93. It thus becomes possible for the objective lens 5 to converge light beams to a spot that is similar in dimension to a spot to be formed in the case where there is no aberration.

Further, it is possible to employ a grating 93 that includes: grating grooves 73b and grating grooves 83b that are formed on a surface of the grating 23; and a layer that is further provided on the surface and made of a material having a higher refractive index than that of the grating 93.

Concretely, it is possible to use glass as a material of the grating 93, and liquid crystal as a material (material having a higher refractive index) that has a higher refractive index than that of the grating 93. An exemplary grating that is structured in a manner such that the layer made of a material having a high refractive index is provided on the grating 93 is a composite grating that is structured in a manner such that a material having a high refractive index is sandwiched between the grating 93 and a sealing member made of the same material as that of the grating 93.

In this case, the composite grating functions as a lens in the opposite manner to the case where no layer made of a material having a high refractive index is provided. Concretely, the grating 93 formed as shown in FIG. 13 functions as a convex lens in the direction 93b_{d} of the grating grooves, whereas the composite grating in which the layer made of a material having a high refractive index is provided on the grating 93 functions as a concave lens in the direction 93b_{d} of the grating grooves.

The grating 93 is designed in a manner such that it functions to make the intensity distribution of the light beam uniform and, at the same time, to cause an astigmatism to be generated in a manner such that the astigmatism offsets an astigmatism caused by the semiconductor laser 1. How the grating 93 corrects astigmatism in the light beam is already described in Embodiment 1, and therefore the description is omitted in the present embodiment.

The present invention is not limited to the description of the embodiments above, but may be altered by a skilled person within the scope of the claims. An embodiment based on a proper combination of technical means disclosed in different embodiments is encompassed in the technical scope of the present invention.

As described above, an optical pickup apparatus according to the present invention includes a grating including grating grooves that cause a first astigmatism to be generated in a manner such that the first astigmatism offsets a second astigmatism caused by the light source. This makes it possible to reduce an astigmatism caused by the light source and an aberration in a spot of light converged by the light converging means. Furthermore, the light-intensity distribution of the main beam, which is a 0th-order diffracted light beam, becomes uniform without reducing efficiency in utilizing light. Accordingly, an advantage is produced that an optical pickup apparatus having excellent focusing characteristics is realized.

It is preferable in the optical pickup apparatus according to the present invention that the grating grooves and the grating ridges of the grating be formed in a manner such that a ratio of the grating grooves to the grating ridges becomes smaller, in a direction of a radiation surface with a wide spread from the light source, from a central area of the grating toward a peripheral area of the grating.

This allows the grating to have a concave lens effect with respect to the direction of the radiation surface with the wide spread from the light source. Therefore, the wide spread of the radiation surface becomes narrower. Consequently, a virtual-source location in a direction of a surface of the radiation surface with the wide spread comes closer to a virtual-source location of a surface perpendicular to the direction of the radiation surface with the wide spread. This produces another advantage that an astigmatic difference included in the light source decreases, and an astigmatism in a light beam having passed through the grating is improved.

Further, it is preferable in the optical pickup apparatus according to the present invention that the grating grooves and grating ridges of the grating be formed in a manner such that a ratio of the grating grooves and the grating ridges becomes greater, in a direction of a radiation surface with a narrow spread from the light source, from a central area of the grating toward a peripheral area of the grating.

This allows the grating to have a convex lens effect with respect to the direction of the radiation surface with the narrow spread from the light source. Therefore, the narrow spread of the radiation surface becomes wider. Consequently, a virtual-source location in a direction of a surface of the radiation surface with the narrow spread comes closer to a virtual-source location of a surface perpendicular to the direction of the radiation surface with the narrow spread. This produces another advantage that an astigmatic difference included in the light source decreases, and an astigmatism in a light beam having passed through the grating is improved.

Further, it is preferable that the optical pickup apparatus according to the present invention include, on a surface of the grating on which surface the grating grooves are provided, a layer made of a material having a higher refractive index than a refractive index of the grating, the grating including the grating grooves and grating ridges that are formed in a manner such that a ratio of the grating grooves to the grating ridges becomes greater, in a direction of a radiation surface with a wide spread from the light source, from a central area of the grating toward a peripheral area of the grating.

This allows the grating to have a concave lens effect with respect to the direction of the radiation surface with the wide spread from the light source. Therefore, the wide spread of the radiation surface becomes narrower. Consequently, a virtual-source location in a direction of a surface of the radiation surface with the wide spread comes closer to a virtual-source location of a surface perpendicular to the direction of the radiation surface with the wide spread. This produces another advantage that an astigmatic difference included in the light source decreases, and an astigmatism in a light beam having passed through the grating is improved.

Further, it is preferable that the optical pickup apparatus according to the present invention include, on a surface of the grating on which surface the grating grooves are provided, a layer made of a material having a higher refractive index than a refractive index of the grating, the grating including the grating grooves and grating ridges of the grating that are formed in a manner such that a ratio of the grating grooves to the grating ridges becomes smaller, in a direction of a radiation surface with a narrow spread from the light source, from a central area of the grating toward a peripheral area of the grating.

This allows the grating to have a convex lens effect with respect to the direction of the radiation surface with the narrow spread from the light source. Therefore, the narrow spread of the radiation surface becomes wider. Consequently, a virtual-source location in a direction of a surface of the radiation surface with the narrow spread comes closer to a virtual-source location of a surface perpendicular to the direction of the radiation surface with the narrow spread. This produces another advantage that an astigmatic difference included in the light source decreases, and an astigmatism in a light beam having passed through the grating is improved.

Further, it is preferable in the optical pickup apparatus according to the present invention that the grating be formed so as to have a characteristic of a cylindrical concave lens which gives rise to a concave lens effect with respect to a direction perpendicular to a direction of the grating grooves.

This allows an influence of an astigmatism included in the light source to be more improved. Therefore, it becomes possible to narrow a spot of light on the storage medium so that the spot becomes nearly as small as an ideal state. This produces an advantage that a signal is recorded and reproduced more suitably.

Further, it is preferable in the optical pickup apparatus according to the present invention that the grating be formed so as to have a characteristic of a cylindrical concave lens which gives rise to a concave lens effect with respect to a direction of the grating grooves.

This allows an influence of an astigmatism included in the light source to be more improved. Therefore, it becomes possible to narrow a spot of light on the storage medium so that the spot becomes nearly as small as an ideal state. This produces an advantage that a signal is recorded and reproduced more suitably.

Further, it is preferable in the optical pickup apparatus according to the present invention that the grating be formed so as to have a characteristic of a cylindrical convex lens which gives rise to a convex lens effect with respect to a direction perpendicular to a direction of the grating grooves.

This allows an influence of an astigmatism included in the light source to be more improved. Therefore, it becomes possible to narrow a spot of light on the storage medium so that the spot becomes nearly as small as an ideal state. This produces an advantage that a signal is recorded and reproduced more suitably.

Further, it is preferable in the optical pickup apparatus according to the present invention that the grating be formed so as to have a characteristic of a cylindrical convex lens which gives rise to a convex lens effect with respect to a direction of the grating grooves.

This allows an influence of an astigmatism included in the light source to be more improved. Therefore, it becomes possible to narrow a spot of light on the storage medium so that the spot becomes nearly as small as an ideal state. This produces an advantage that a signal is recorded and reproduced more suitably.

Further, it is preferable in the optical pickup apparatus according to the present invention that the grating be formed so as to have a characteristic in which ±1st-order diffraction efficiency becomes smaller, in a direction perpendicular to a direction of the grating grooves, from a central area of an incident light beam.

This causes the intensity distribution of the light beam to become uniform in the direction perpendicular to the direction of the grating grooves. This produces an advantage that the intensity distribution of the light beam incident on the objective lens is shaped so that a desired reproduction characteristic is obtained.

Further, it is preferable in the optical pickup apparatus according to the present invention that the grating is formed so as to have a characteristic in which ±1st-order diffraction efficiency becomes smaller, in the direction of the grating grooves, from a central area of an incident light beam.

This causes the intensity distribution of the light beam to become uniform in the direction of the grating grooves. This produces an advantage that the intensity distribution of the light beam incident on the objective lens is shaped so that a desired reproduction characteristic is obtained.

Further, it is preferable in the optical pickup apparatus according to the present invention that the grating be a relief grating that includes, on a glass substrate, grating grooves formed with a period structure.

Because the grating is a relief grating, it is possible to produce the grating with the use of an existing production apparatus such as an etching apparatus. This produces another advantage that mass production of the grating becomes possible at lower costs.

Further, it is preferable in the optical pickup apparatus according to the present invention that the grating be a multi-beam generation grating for splitting, into at least three light beams, a light beam that is to be converged to the storage medium.

Because the grating is a multi-beam generation grating, it becomes possible to control tracking by use of three or more light beams. This produces another advantage that a signal is recorded and reproduced more stably.

Further, it is preferable that the optical pickup apparatus according to the present invention further include a light receiving device, the grating guiding a reflected light beam from the storage medium to the light receiving device.

This makes it possible to reduce the number of components. This produces an advantage that the size and costs are reduced.

Further, an optical recording and reproducing apparatus that employs an optical pickup apparatus of the present invention has excellent focusing characteristics. Thus, use of an optical recording and reproducing apparatus of the present invention produces an advantage that recording and reproduction with a storage medium is suitably performed.

As the foregoing describes, the optical pickup apparatus according to the present invention allows an astigmatism caused by the light source to be reduced. Further, the optical pickup apparatus allows an aberration in the spot of light converged by the light converging means to be reduced. Furthermore, the optical pickup apparatus according to the present invention allows the light-intensity distribution of the main beam, which is a 0th-order diffracted light beam, to become uniform without reducing efficiency in utilizing light. Accordingly, an optical pickup apparatus having excellent focusing characteristics is realized. This allows the optical pickup apparatus of the present invention to be suitably applied to an optical recording and reproducing apparatus that optically records and/or reproduces information with a storage medium such as an optical disk. Thus, the optical pickup apparatus according to the present invention is applicable to various fields of electrical products, including home appliances and industrial facilities.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. An optical pickup apparatus, comprising:
a light source that emits a light beam;
light converging means for converging the light beam to a storage medium; and
a grating that guides the light beam to the light converging means,
the light converging means converging, to the storage medium via the grating, the light beam emitted from the light source, and
the grating including grating grooves that cause a first astigmatism to be generated in a manner such that the first astigmatism offsets a second astigmatism caused by the light source.

2. The optical pickup apparatus according to claim 1, wherein the grating grooves and grating ridges of the grating are formed in a manner such that a ratio of the grating grooves to the grating ridges becomes smaller, in a direction of a radiation surface with a wide spread from the light source, from a central area of the grating toward a peripheral area of the grating.

3. The optical pickup apparatus according to claim 1, wherein the grating grooves and grating ridges of the grating are formed in a manner such that a ratio of the grating grooves to the grating ridges becomes greater, in a direction of a radiation surface with a narrow spread from the light source, from a central area of the grating toward a peripheral area of the grating.

4. The optical pickup apparatus according to claim 1, further comprising, on a surface of the grating on which surface the grating grooves are provided, a layer made of a material having a higher refractive index than a refractive index of the grating,
the grating including the grating grooves and grating ridges that are formed in a manner such that a ratio of the grating grooves to the grating ridges becomes greater, in a direction of a radiation surface with a wide spread from the light source, from a central area of the grating toward a peripheral area of the grating.

5. The optical pickup apparatus according to claim 1, further comprising, on a surface of the grating on which surface the grating grooves are provided, a layer made of a material having a higher refractive index than a refractive index of the grating,
the grating including the grating grooves and grating ridges of the grating that are formed in a manner such that a ratio of the grating grooves to the grating ridges becomes smaller, in a direction of a radiation surface with a narrow spread from the light source, from a central area of the grating toward a peripheral area of the grating.

6. The optical pickup apparatus according to claim 1, wherein the grating is formed so as to have a characteristic of a cylindrical concave lens which gives rise to a concave lens effect with respect to a direction perpendicular to a direction of the grating grooves.

7. The optical pickup apparatus according to claim 1, wherein the grating is formed so as to have a characteristic of a cylindrical concave lens which gives rise to a concave lens effect with respect to a direction of the grating grooves.

8. The optical pickup apparatus according to claim 1, wherein the grating is formed so as to have a characteristic of a cylindrical convex lens which gives rise to a convex lens effect with respect to a direction perpendicular to a direction of the grating grooves.

9. The optical pickup apparatus according to claim 1, wherein the grating is formed so as to have a characteristic of a cylindrical convex lens which gives rise to a convex lens effect with respect to a direction of the grating grooves.

10. The optical pickup apparatus according to claim 1, wherein the grating is formed so as to have a characteristic in which ±1st-order diffraction efficiency becomes smaller, in a direction perpendicular to a direction of the grating grooves, from a central area of an incident light beam.

11. The optical pickup apparatus according to claim 1, wherein the grating is formed so as to have a characteristic in which ±1st-order diffraction efficiency becomes smaller, in a direction of the grating grooves, from a central area of an incident light beam.

12. The optical pickup apparatus according to claim 1, wherein the grating is a relief grating that includes, on a glass substrate, grating grooves formed with a period structure.

13. The optical pickup apparatus according to claim 1, wherein the grating is a multi-beam generation grating for splitting, into at least three light beams, a light beam that is to be converged to the storage medium.

14. The optical pickup apparatus according to claim 1, further comprising a light receiving device,
the grating guiding a reflected light beam from the storage medium to the light receiving device.

15. An optical recording and reproducing apparatus, comprising an optical pickup apparatus,
the optical pickup apparatus including:
a light source that emits a light beam;
light converging means for converging the light beam to a storage medium; and
a grating that guides the light beam to the light converging means,
the light converging means converging, to the storage medium via the grating, the light beam emitted from the light source, and
the grating including grating grooves that cause a first astigmatism to be generated in a manner such that the first astigmatism offsets a second astigmatism caused by the light source.
